(19) United States
(12) Patent Application Publication
(10) Pub. No.: US 2023/0235546 A1
(43) Pub. Date: Jul. 27, 2023

(54) SYSTEM AND METHOD FOR LINING PIPE WHILE MAINTAINING FLOW THERETHROUGH

(71) Applicant: PIPE LINING ENTERPRISES, INC., FORT LAUDERDALE, FL (US)

(72) Inventor: Larry W. Kiest, JR., Fort Lauderdale, FL (US)

(21) Appl. No.: 18/158,956

(22) Filed: Jan. 24, 2023

Related U.S. Application Data
(60) Provisional application No. 63/267,079, filed on Jan. 24, 2022.

(51) Int. Cl. E03F 7/02; F16L 55/134; F16L 55/18; E03F 5/02

(52) U.S. Cl. CPC E03F 7/02; E03F 5/02; F16L 55/18; F16L 55/134

(57) ABSTRACT

During rehabilitation of a pipe system, such as one or more pipes of a sewer pipe system, a cleanout provides access the pipe system. The cleanout is used to plug an upstream portion of the pipe system and to allow for access to monitor the rehabilitation of the system, which may utilize CIPP repair. The plug includes a flow-through portion to allow for the removal of sewage in the blocked or plugged pipe, which allows for the continued use of the sewage system via a house, residence, or other structure connected to the sewer pipe system. An alert can be used as well to allow for the selective removal of sewage via the flow through plug and an associated removal pipe.

### CROSS REFERENCE TO RELATED APPLICATIONS

This application claims priority under 35 U.S.C. § 119 to provisional patent application U.S. Serial No. 63/267,079, filed Jan. 24, 2022. The provisional patent application is herein incorporated by reference in its entirety, including without limitation, the specification, claims, and abstract, as well as any figures, tables, appendices, or drawings thereof.

### FIELD OF THE INVENTION

The invention relates generally to pipe repair. More particularly, but not exclusively, the invention relates to systems, methods, and/or apparatus for trenchless pipe repair that allows for the repair of a lateral pipe to a residence or other building, and blocking flow without interrupting the service of the pipe for the residence.

### BACKGROUND OF THE INVENTION

Many municipalities have buried infrastructure. Sewer systems are a buried infrastructure that provides access points such as manhole and cleanouts. The main sewer pipe extends between an upstream and a downstream manhole, and a number of service pipes extend laterally from the main pipes. These service/lateral pipes may extend to existing structures, such as buildings (residential, business, etc.). In many instances, the pipe systems are aged and require repair. Trenchless pipe repair methods are commonly used to repair or renew the pipe by accessing the pipe through access points. This access may also be used for installing conduits or cables to and through pipelines and avoiding the need for excavation.

Over the last 50 years, the rehabilitation method for old crumbling and leaking pipelines has changed from excavation and replacement of old pipeline to using low disruptive, low cost, very fast, and effective cured-in-place-pipe (CIPP) technology. The technology concept includes using the old pipe as a form or mold for the installation of a liner to create a new pipe. The technique includes, first cleaning the existing pipeline, manufacturing a fabric tube to fit the existing pipe, saturating the fabric tube with a thermoset resin, temporarily stopping all flow from entering the old pipe, installing the saturated fabric tube into the existing pipeline, curing the thermoset resin using a variety of techniques, and then restoring flow to the rehabilitated pipeline. In particular, a main pipe is lined first, and the lateral pipes connected to the main pipe need to be plugged.

Since its invention and early installation, ClPP technology has been improved with new innovations, applications, better materials, more efficient delivery and installation methods, and faster and diversified curing techniques.

The acceptance and accelerated use of the CIPP technology while driven, to a great extent, by the lower associated cost to install but also with the significant reduction in the environmental and social impacts associated with traditional pipeline replacement. Ideally, to obtain repeatability and high material quality, the resin saturated liner must be manufactured in a controlled environment free of contamination of active sewage flow. In the field construction environment, the process of creating a new cured-in-place pipe is not always ideal. After nearly 50 years and tens of thousands of miles of CIPP installations, installed quality levels fall short of the potential quality and expectations. Poor installation conditions less focus on quality, more emphasis on production and lower costs are often the plan.

In addition, during installation, access to the sewage system from a house or other structure many be limited or even cut off. A cleanout pipe is used to access a service/lateral pipe extending from the home to a main pipe, and a plug is inserted therein to block flow into the main pipe. This provides a system that then can be repaired using the CIPP process and system to repair the main pipe and possibly even a portion of the lateral/service pipe.

Home or building occupants may be provided with notice that the sewer access will be blocked during the repair process. This may be done by note left at their residence, door to door communication, or other ways to let the occupants know of downtime for the sewer system. However, this is not perfect, and occupants may not be aware or may not remember of the situation, and they may use the sewer system as normal. With the plug in place, this can back up the service pipe, which can cause problems, such as smells or even back-flooding of the sewage into the residence or other building. The CIPP process can also produce emissions containing VOC’s which can migrate up a service pipe and enter the residence through a dry plumbing fixture trap.

Thus, there exists a need in the art for an apparatus, system, and/or method to prevent CIPP emissions from migrating into a building and allow for the purposeful or accidental use of a service/lateral sewer line from a home or other structure during the blockage of the service/lateral line, such as for the repair of the sewer system, such as the main pipe and/or service line itself.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the invention to improve on or overcome the deficiencies in the art.

It is a further object, feature, and/or advantage of the invention to rehab an existing pipe of a pipe system, such as a sewer lateral pipe and/or a main pipe of a sewer system.

It is still yet a further object, feature, and/or advantage of the invention to provide systems, methods, and/or apparatus that allow for the flow through of sewage in a pipe that is blocked during the rehabilitation of one or more pipes of a sewer pipe system.

It is yet another object, feature, and/or advantage to provide a plug system and/or apparatus that includes a plug portion to block flow in a sewer pipe, and an associated flow-through pipe to allow for sewage blocked by the plug to be removed from the pipe.

It is still a further object, feature, and/or advantage to mitigate CIPP emissions from backflowing into the structure to protect any occupants thereof. As will be understood, the mitigation of the emissions protects the occupant’s health and safety.

It is still a further object, feature, and/or advantage to provide an alert system for use with a flow-through plug in a lateral pipe to alert if the blocked lateral pipe needs evacuated.

It is yet another object, feature, and/or advantage to provide an evacuation system associated with the lateral pipe including the flow-through plug to selectively evacuate the pipe to mitigate backflow and flooding.

The system and/or apparatus disclosed herein can be used in a wide variety of applications. For example, any pipe system that needs temporarily blocked for repair/rehabilitation can include the flow-through plug.

It is preferred the apparatus be safe, cost effective, and durable. For example, the system should be easy to use and position to mitigate the issues with a blocked sewer pipe.

At least one embodiment disclosed herein comprises a distinct aesthetic appearance. Ornamental aspects included in such an embodiment can help capture a consumer’s attention and/or identify a source of origin of a product being sold. Said ornamental aspects will not impede functionality of the invention.

Methods can be practiced which facilitate use, manufacture, assembly, maintenance, and repair of the flow-through plug, which accomplish some or all of the previously stated objectives.

The flow-through plug and associated systems and methods can be incorporated into systems or kits which accomplish some or all of the previously stated objectives.

According to some aspects of the present disclosure, a flow-through plug system for use in repairing one or more pipes of a sewer pipe system comprises a pipe section comprising an upper portion and a lower portion extending at an angle relative to the upper portion; a plug positioned on the lower portion of the pipe section and substantially surrounding said lower portion; and a fluid source operatively connected to the plug to expand said plug in a pipe of the sewer pipe system, wherein the plug substantially blocks flow in the pipe when expanded.

According to at least some embodiments of some aspects, the plug comprises a resilient material.

According to at least some embodiments of some aspects, the plug comprises a rubber material fluidly sealed on the pipe section.

According to at least some embodiments of some aspects, the lower portion of the pipe section extends from the upper portion at an angle between about 45-degrees and about 135-degrees.

According to at least some embodiments of some aspects, the lower portion of the pipe section extends from the upper portion at an approximately 90-degree angle.

According to at least some embodiments of some aspects, the system further comprises an extension conduit operatively connected to the upper portion of the pipe section.

According to at least some embodiments of some aspects, the system further comprises an evacuation system operatively connected to the extension conduit.

According to at least some embodiments of some aspects, the evacuation system comprises a. a vacuum truck; b. a pump connected to a container; or c. a pump connected to a second pipe system.

According to at least some embodiments of some aspects, the system further comprises an alert system operatively connected to the pipe section for alerting the presence of sewage.

According to at least some embodiments of some aspects, the fluid source comprises an air source for inflating the plug.

According to additional aspects, a method of repairing a section of a pipe system comprises connecting to a pipe of the pipe system via a cleanout in the ground and an aperture through a wall of the pipe; plugging a section of the pipe using a flow-through plug system comprising a pipe section comprising an upper portion and a lower portion extending at an angle relative to the upper portion, and a plug positioned on the lower portion of the pipe section and substantially surrounding said lower portion, wherein the plug is expanded against the pipe; repairing the pipe downstream of the flow-through plug system using a CIPP repair system.

According to at least some embodiments of some aspects, the method further comprises evacuating material that is at an upstream location of the flow-through plug system via the flow-through pipe section.

According to at least some embodiments of some aspects, an extension conduit is connected to the pipe section to aid in directing the material via the flow-through plug system.

According to at least some embodiments of some aspects, the step of evacuating material comprises using a vacuum to move the material from the pipe to an evacuation location.

According to at least some embodiments of some aspects, the method further comprises monitoring the presence of material at an upstream location of the flow-through plug system to provide a visual identification when material is present thereat.

According to at least some embodiments of some aspects, the method further comprises expanding the plug by inflating said plug with a fluid.

According to still additional aspects, a system for repairing a pipe comprises a flow-through plug system comprising a pipe section comprising an upper portion and a lower portion extending at an angle relative to the upper portion, and a plug positioned on the lower portion of the pipe section and substantially surrounding said lower portion, wherein the plug is expanded against the pipe; a fluid source for expanding the plug in the pipe; and an evacuation system to move material from within the pipe and through the flow-through plug system to an evacuation location.

According to at least some embodiments of some aspects, the system further comprises an extension conduit connecting the pipe section of the flow-through plug system and the evacuation location.

According to at least some embodiments of some aspects, the system further comprises a pump to move the material via the flow-through plug system and extension conduit.

According to at least some embodiments of some aspects, the system further comprises a monitoring system to provide visual indication, at a location external of the pipe, of the present of material in the pipe to be evacuated via the flow-through plug system and extension conduit.

According to at least some embodiments of some aspects, the lower portion of the pipe section extends from the upper portion at an angle between about 45-degrees and about 135-degrees.

According to at least some embodiments of some aspects, the lower portion of the pipe section extends from the upper portion at an approximately 90-degree angle.

According to additional aspects, a flow-through plug system for use in repairing one or more pipes of a sewer pipe system, said pipe system comprising a main pipe and at least one lateral pipe extending therefrom, and wherein a cleanout is provided to access the at least one lateral pipe via the cleanout comprises a pipe section comprising an upper portion and a lower portion extending at an angle relative to the upper portion; a plug positioned on the lower portion of the pipe section and substantially surrounding said lower portion; and a fluid source operatively connected to the plug to expand said plug in a pipe of the sewer pipe system, wherein the plug substantially blocks flow in the pipe when expanded; wherein the pipe section and plug inserted via the cleanout to a location where the lower portion is positioned in and facing an upstream portion of the at least one lateral pipe and the upper portion at least partially in the cleanout, and when inflated, the plug contacting the wall of the at least one lateral pipe.

According to at least some embodiments of some aspects, the plug comprises a resilient material.

According to at least some embodiments of some aspects, the plug comprises a rubber material fluidly sealed on the pipe section.

According to at least some embodiments of some aspects, the lower portion of the pipe section extends from the upper portion at an angle between about 45-degrees and about 135-degrees.

According to at least some embodiments of some aspects, the lower portion of the pipe section extends from the upper portion at an approximately 90-degree angle.

According to at least some embodiments of some aspects, the system further comprises an extension conduit operatively connected to the upper portion of the pipe section.

According to at least some embodiments of some aspects, the system further comprises an evacuation system operatively connected to the extension conduit.

According to at least some embodiments of some aspects, the evacuation system comprises: a. a portable vacuum or a vacuum truck; b. a pump connected to a container; or c. a pump connected to a second pipe system.

According to at least some embodiments of some aspects, the system further comprises an alert system operatively connected to the pipe section for alerting the presence of sewage.

According to at least some embodiments of some aspects, the fluid source comprises an air source for inflating the plug.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a sectional view of an exemplary sewer system including a manhole, main pipe, and multiple service or lateral pipes.

FIG. 2 is a sectional view showing an exemplary pipe system including a main pipe with a lateral pipe extending to a building and a cleanout providing access to the lateral pipe.

FIG. 3 is a sectional view of the pipe system of FIG. 2 showing aspects and/or embodiments of a flow-through plug and associated system.

FIG. 4 is an exemplary view of a flow-through plug system according to aspects and/or embodiments of the present disclosure.

FIG. 5 is an exemplary view of the flow-through plug system being positioned in an exemplary pipe,

FIG. 6 is an exemplary view of the flow-through plug in the exemplary pipe with the plug in a non-inflated configuration.

FIG. 7 is a view similar to FIG. 6, but with the flow-through plug in an inflated configuration.

FIG. 8 is a view of another pipe system showing aspects and/or embodiments of the present disclosure.

FIG. 9 is a view of yet another pipe system showing aspects and/or embodiments of the present disclosure.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

The terms “pipe system”, “main pipe”, “lateral pipe”, “service pipe”, and “cleanout” are intended to mean that which is known in the CIPP industry.

A “pipe liner” is defined as a material that is used to provide a lining to a pipe. Pipe liners include but are not limited to cured-in-place pipe liners, folded liners, or spray-on liners.

A “cured-in-place pipe liner” is a fabric capable of holding a resinous material.

A “folded liner” is a material constructed of a thermoplastic, such as High Pressure Polyethylene (“HPPE”), High Density Polyethylene (“HDPE”), Medium Density Polyethylene (“MDPE”), Polyvinyl Chloride (“PVC”), and/or modified PVC that is used to provide a lining to pipes.

A “main liner” or “main pipe liner” is defined as a pipe liner for use inside of a main sewer pipe.

A “manhole liner” is defined as a material that is used to provide a lining to a manhole. Manhole liners include but are not limited to cured-in-place manhole liners, spray-on manhole liners, cementitious manhole liners, cast-in-place manhole liners, and resin manhole liners.

A “cured-in-place manhole liner” is a fabric or textile capable of holding a resinous material and conforming to a manhole structure

A “spray-on liner” is defined as a material that is used to provide a lining to a manhole or pipe where the material is sprayed onto the walls of the manhole or pipe.

A “cementitious liner” is defined as a cement material that is used to provide a lining to a manhole. Cementitious liners may usually be sprayed, spread, or otherwise placed onto the walls of the manhole.

A “resin liner” is defined as a resinous material that is used to provide a lining to a manhole. Resin liners may be sprayed, spread, or otherwise placed onto the walls of the manhole.

A “service pipe” is defined as a pipe that is lateral to a main pipe.

The terms “residence”, “house”, “building”, or “other structure” are intended to be used interchangeably as a location to which a service or lateral pipe extends from a main pipe to provide sewer services thereto.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

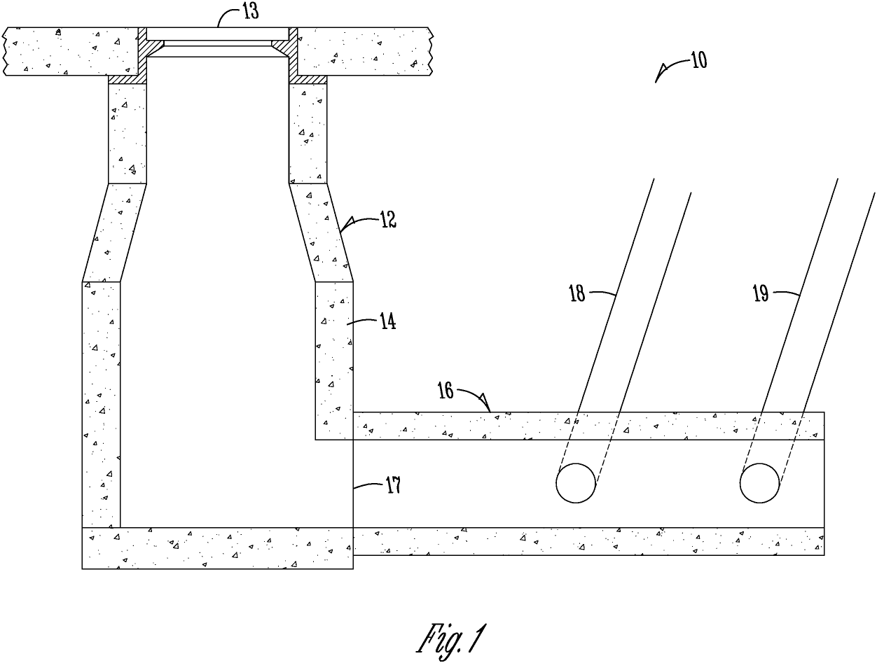

FIG. 1 is an exemplary sectional view of a pipe system 10. The pipe system 10 includes various components which may comprise an exemplary pipe system. However, it should be appreciated that generally any type of pipe system and/or sewage system such as may be used in infrastructure and municipalities, and which may be in need of or have been repair may be considered as part of the disclosure. The pipe system 10 shown in FIG. 1 includes a manhole 12. The manhole 12 includes an opening or access cover 13 to provide access into the manhole 12. The manhole includes walls 14 forming the structure of said manhole 12. Extending from an opening the 17 in a wall 14 of the manhole 12 is a main pipe 16. The main pipe is a term not to be limiting or meaning anything in particular, and instead is included to refer to a specific pipe in the figures. The main pipe includes walls extending a distance from the manhole 12 and may extend from one manhole to another. Generally extending from the main pipe 16 are lateral pipes 18, 19. The lateral pipes 18, 19 may also be referred to as service pipes or user pipes and extend generally from the main pipe 16 to a building, lot, or other location. For example, the lateral pipes may extend from the main pipe 16 to a dwelling, such as a house, building, place of business, or other structure. The lateral pipes are connected in such a manner that the sewage and other fluids flow from the end location, such as the dwelling, towards the main pipe 16.

Many municipalities include such exemplary pipe systems 10 as shown in FIG. 1, and many of said pipe systems have been in place for an extensive period of time. For example, the pipe systems are generally comprising concrete, vitrified clay, iron, or the like, and the pipe systems can experience wear and tear. Such wear and tear can take many forms, including, while not limited to, freeze and thaw, leakage, subsidence, water erosion, corrosion, cracking, settling, rusting, plant root intrusion or other, or the like. Any penetration or opening in a pipe can allow groundwater and soil to enter, which can block or otherwise overload the pipe system. Such damage to the structure of the systems require repair. While one type of repair is to dig up the area in and around the pipes and to structurally replace the pipes, this is very costly, disruptive and intrusive. For example, a large amount of ground must be displaced in order to access the underground pipes, then the pipes must be torn out and replaced, then the ground replaced, and the surface restored. Therefore, many times cured-in-place (CIPP) pipe lining repair is utilized to repair one or more components (pipe or section or pipe) of the pipe system 10.

CIPP pipe repair, such as is disclosed in U.S. Pat. numbers 9,562,339, 8,550,121, and 9,435,479, which are hereby incorporated by reference in their entirety, includes inverting a resin impregnated liner into a pipe from outside on inside the pipe, such as within an inflatable bladder. For example, when repairing the main pipe 16, the bladder and liner combination may start in the manhole 12 and be inverted into the main pipe 16 via the opening 17. Otherwise, when repairing the lateral pipes 18, 19, access may be started in the manhole or the main pipe. In either sense, little to no ground is as disrupted to provide repair to the pipes. The resin impregnated liner can be cured via an ambient curing agent, a heat source which can be circulated hot water, steam/air mixture, or other (e.g., light, such as ultraviolet light). Currently, steam curing is the most widely used process for curing CIPP. The steam aids in speeding up the curing process of the resin saturated liner in order to provide a new pipe within a pipe that significantly extends the service life of the pipe.

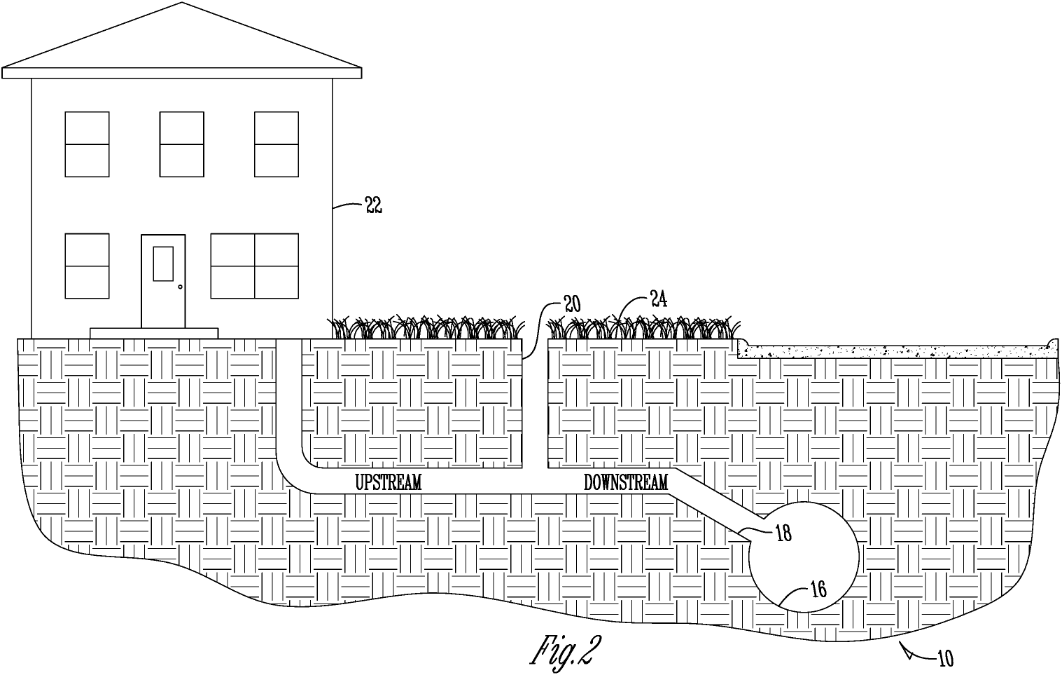

FIG. 2 shows another view of a pipe system 10. As shown in FIG. 2, the pipe system 10 includes a main pipe 16, which is appearing to extend transversely to the surface of the figure. A lateral or service pipe 18 is shown to extend from the main pipe 16 and ultimately ending or connecting with a structure 22. The structure may be any structure having a need for sewer connection, including, but not limited to residences, houses, office buildings, storage buildings, garages, or the like. It should be appreciated that generally any structure having a connection via a pipe system for sewage is to be contemplated. The service or lateral pipe 18 carries material, such as sewage, water, and the like, from the structure 22, through the service pipe 18, and towards the main pipe 16.

The main pipe 16 of the municipality may be connected to multiple structures, such as the structure 22 in the figure, via multiple service pipes along the length of the main pipe 16. From time to time, the main pipe 16, and even some or all of the lateral pipe(s) 18, may need to be repaired, and CIPP repair processes and systems are utilized. This allows for the trenchless and minimally invasive repair of a section or entirety of a pipe or pipes, such as by any of the disclosures referenced and incorporated by reference herein. In addition, to provide access to the pipe system 10 as part of the CIPP process, a cleanout 20 may be needed or otherwise dug to provide access to a lateral pipe 18. A cleanout is created by digging a hole or otherwise removing ground 24 (e.g., via a vacuum system), a hole is created in the lateral pipe at the cleanout, and a saddle or other member can be connected, either temporarily or permanently, to the lateral pipe. Such a process and/or system is shown in U.S. Pat. Nos. 6,705,801; 8,454,271; 8,172,482; all of which are herein incorporated by reference in their entirety.

Most service lateral pipes, such as the pipe 18 in the figures, do not have a clean out at the property line (i.e., ground 24). The property line is the point where the public right away meets private property, for example the upstream side of a sidewalk could be a property line in a municipality. The process for installing a cleanout 20 can be practiced using ASTM F3097, whereby a minimally invasive sewer cleanout is installed. ASTM F3097 is hereby incorporated by reference in its entirety and for all purposes. Typically, the cleanout connects to the lateral pipe with a TEE shape, providing access both upstream and downstream of the cleanout (see, e.g., FIG. 2 for depiction of upstream/downstream). For reference, ASTM F3097 provides the standard for minimally invasive cleanout installation that utilizes a saddle and provides the two-way access.

The newly installed cleanout provides two-way access for both upstream and downstream in the lateral pipeline 18 through a T-shaped clean out that is made by using a saddle a pipe saddle, such as that disclosed in any of the referenced and incorporated patents.

The cleanout 20 is used to provide access to the pipe system 10 and to provide additional advantages. For example, equipment, such as cameras and the like, are able to be inserted via the cleanout 20 to monitor the repair process from an upstream location of the repair. In addition, as mentioned herein, a bladder or plug can be inserted through the cleanout 20 and positioned at a location upstream of the cleanout (such as between the cleanout and the structure) to plug or block sewage and any other material from moving from the structure 22, through the lateral/service pipe 18, and into the main pipe 16. This is important during the CIPP process to ensure that the repair retains structural integrity. Municipalities typically are responsible for the maintenance and rehabilitation for service pipes located in the public right away. Typical practices have included inserting an inflatable sewer plug on the upstream side of the cleanout 20 to prevent or at least mitigate system flow into the portion of the sewer lateral located in the public right of way. This sewer plug (not shown) also prevents or at least mitigates any emissions produced from curing of the thermal-setting resin, which could migrate up the service pipe and enter a home or business (i.e., a structure 22) through a dry plumbing fixture trap. For this reason, it is important that the service lateral be plugged during any pipe rehabilitation processes.

A plug in the pipe means service is interrupted, and there are times that service cannot be interrupted. There is also risk for damage to property, such as a basement where sewage could overflow/backflow in a home or business when the service lateral is plugged. This generally occurs when the occupants are either unaware of the pipe repair or otherwise forget or ignore the fact that use of the pipes could be affected by the pipe repair.

Therefore, there is an opportunity to improve rehabilitation processes by stopping system flow, protecting the homeowner from emissions, and maintaining sewer system service without contaminating section of the pipe being rehabilitated.

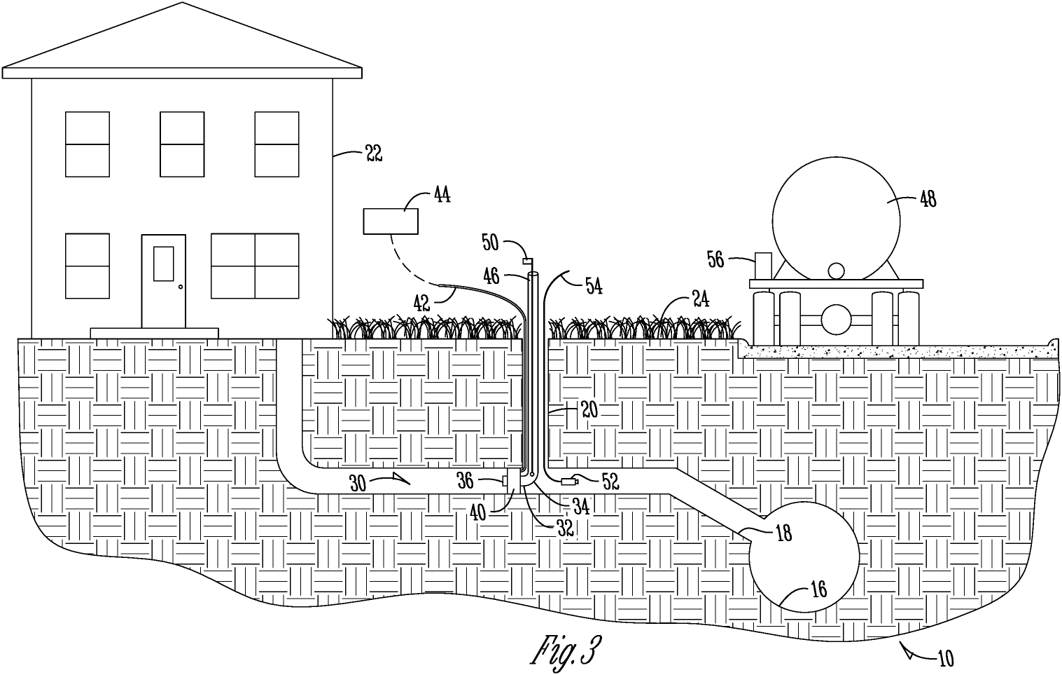

Such an improvement is shown in FIG. 3. As shown in the figure, a flow-through plug system 30 is included at a location upstream of the cleanout pipe 20 in the service lateral pipe 18. As will be understood, features and/or advantages of the flow-through plug system 30 according to aspects and/or embodiments of the present disclosure include a plug or bladder 40 being outfitted with a flow-through pipe section 32 capable of passing sewage flow through the pipe and the pipe being connected to a vacuum source or other evacuation source to evacuate the sewage. A purpose is to plug the upstream side of the cleanout 20 taking the sewer lateral pipe 18 out of service so the pipe downstream of the clean out to the city-owned main pipe is not affected by sewage flow, yet the building occupants have sewer service maintained and there is little to no interruption to service.

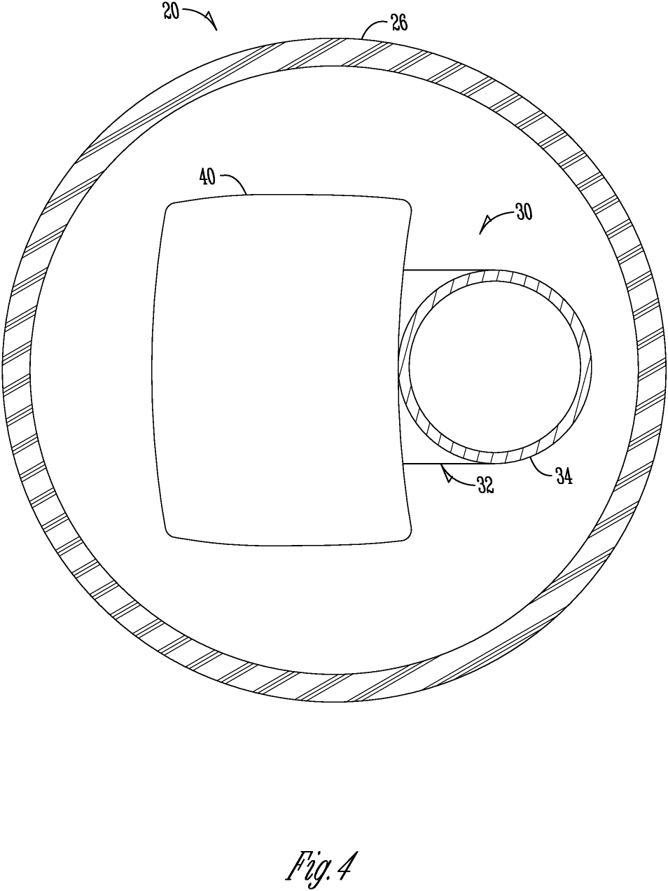

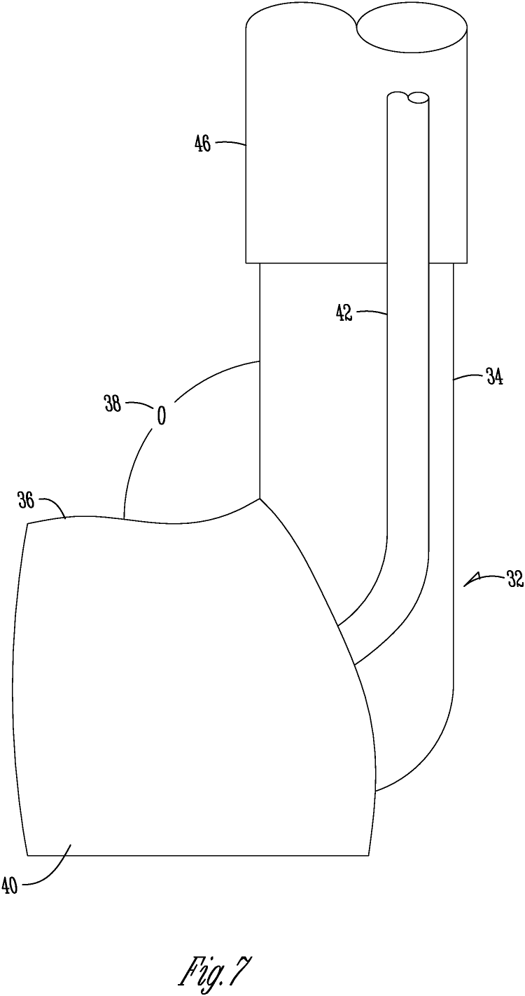

An exemplary flow-through plug system 30 is shown in greater detail in FIGS. 4-7. The system 30 includes a pipe 32 comprises a rigid material, such as steel. The pipe section 32 includes an upper portion 34 and a lower portion 36 extending at an angle from the upper portion 34. The angle 38, such as that shown best in FIG. 7, may be configured to best allow flow from a lateral pipe and into the pipe section 32. Thus, it is envisioned that, according to some embodiments, the angle 38 may be from about 45-degrees to about 135-degrees. In additional embodiments, the angle 38 may be approximately 90-degrees between the upper portion 34 and the lower portion 36. In addition, the length of the upper and/or lower portion may vary. For example, the lower portion may extend just enough of a length to be positioned into a lateral pipe 18, but, as shown best in FIG. 4, will be less than the diameter of the cleanout pipe 20.

The upper portion 34 can also be less than the length of the clean out pipe 20. In such an embodiment, an extension conduit 46, which may comprise a flexible conduit, can be fluidly attached to the upper portion 34 to provide length and connection between the pipe section 32 and an evacuation location/system 48, as will be understood. The extension conduit 46 could be attached to the pipe 32 via chemical connection (e.g., adhesive, bonding, etc.), welding, or by mechanical fasteners (e.g., clamps, elastic member, or the like). The exact manner of connecting the extension to the pipe is not to be limiting on the disclosure. In addition, while it has been included that the extension is flexible, this allows for the maneuverability of the pipe, and it is also to be appreciated that the conduit could be rigid.

In addition, the diameter of the pipe section 32, including both upper and lower portions, can be set to be less than the cleanout pipe. As shown in FIG. 3, the plug is placed through the cleanout 20, and a camera 52 with cable 54 can also be included to monitor the repair of the pipe system 10 via CIPP repair processes.

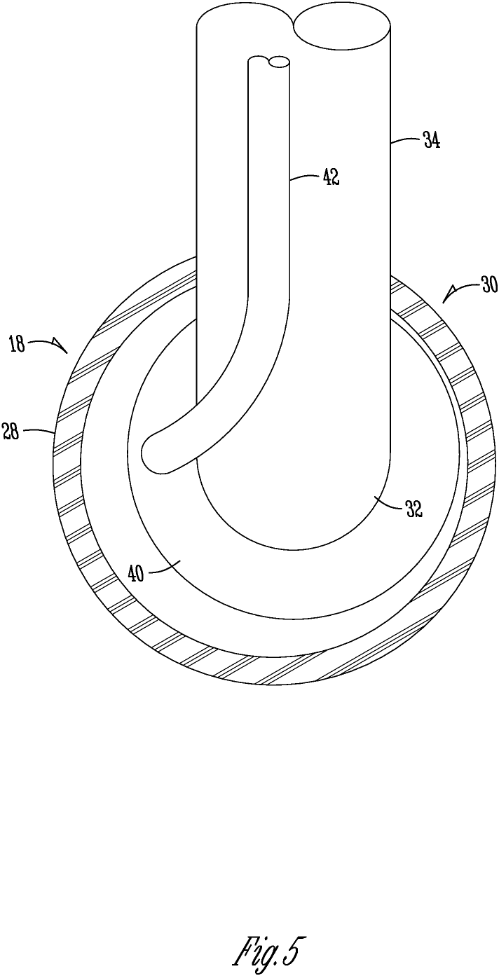

Also part of the plug system 30 is a plug or bladder 40 positioned at and around at least a portion of the pipe section 32, such as at the lower portion 36. As shown in FIG. 7, the plug 40 covers a portion of the lower portion 36 as well as part of the angle and/or portion of the upper portion 34. The plug/bladder 40 comprises an inflated or otherwise pliable material, such as rubber, silicone, or the like, which can expand or be filled with a fluid, such as air, steam, water, or the like. Thus, the plug will have an internal surface generally contacting the pipe section 32. As shown in FIG. 5, when non-inflated, the plug and pipe will have an overall diameter that is less than that of the lateral pipe 18. This is shown by a space between the plug 40 and the wall 28 of the lateral pipe 18.

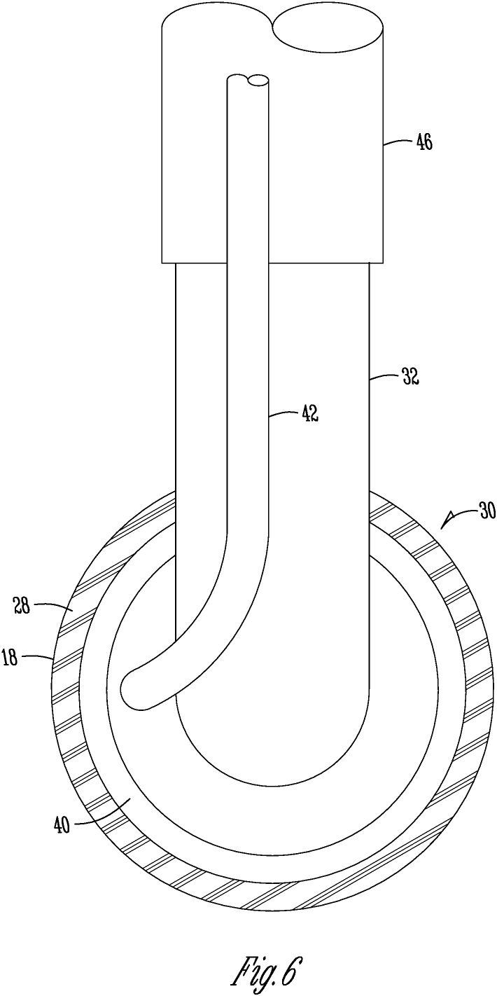

An outer portion/wall will, when expanded, will grow the outer diameter of the plug to contact the wall 28 of the lateral pipe 18, such as shown in FIG. 6. To inflate or otherwise expand the plug 40 between the configurations of FIGS. 5 and 6, a fluid can be added to an interior of the plug 40. This can be accomplished via an input line or conduit 42. According to some aspects of some embodiments, the conduit 42 is an air line connected to an air source 44 (e.g., a fan or blower), which may be located external of the pipe. Air is added via the air source 44 and conduit 42 to the interior of the plug 44 to expand the same into contact with the wall 28 of the lateral pipe 18.

Still further, the plug may comprise an inverted-style plug. As is known with inversion process, a forward inverting face will include a portion that extends towards the rear or tail, where it is connected to a blower or fan to provide the force for inversion. A flexible suction hose could be connected/attached at the tail end of the inverting bladder, which would receive any of the flow through sewage that may pass through the inverting face of the bladder. This would still provide the blocking of the flow of sewage at the upstream portion of the lateral pipe, which protects public health due to the mitigation of emissions and would also allow for the usage of the lateral pipe while mitigating the addition of sewage to the downstream portion of the lateral pipe, where the pipe rehabilitation occurs.

However, as the pipe section 32 (i.e., the lower portion 36 thereof) extends through the plug 40, it will be interfacing the interior of the lateral pipe 18, such as is shown in FIG. 3. This will allow for any material, such as sewage, that is added to the lateral pipe 18 to be evacuated through the pipe section 32 in the middle of the plug and then out the extension conduit 46 to an evacuation location/system.

For example, the evacuation system 48 may be a vacuum truck, pump connecting to another sewer line, or a vacuum or pump connected to a container or other containment system. The pump or vacuum 56 can be activated to move the sewage through the plug system 30 and towards the evacuation system to maintain flow through the pipe system during repair.

Additional aspects of the disclosure include the use of a visual aid, such as an alert 50, that indicates the presence of sewage material in the lateral pipe that needs evacuated. FIG. 3 includes the use of a flag 50. The flag could be activated, similar to a fishing bobber, to alert the presence of material to be evacuated. Still further, a sensor system, such as an electronic sensor system in the flow-through plug system 30, could indicate the presence of a material in the pipe. For example, the lower portion 36 of the pipe section 32 could include visual sensors, pressure sensors, fluid sensors, gas sensors, ultrasonic sensors, electromechanical sensors, pneumatic sensors, magnetic sensors inductive sensors, capacitive sensors, photoelectric sensors, or any other sensor could be included to indicate the present of a material (e.g., sewage) in the pipe.

Still further, it is envisioned that the sensors could be connected to the evacuation system such that the evacuation system automatically operates upon detection/indication of material in the pipe.

It is to be appreciated that the systems, apparatus, and/or processes disclosed are envisioned to be used with pipe systems, such as one having a lateral pipe connected to a main pipe. As noted, the lateral pipe can be accessed by having a two-way cleanout with either a tee-shaped fitting or a vacatee (see, e.g., ASTM F3097). The plug system, such as that disclosed herein, can be positioned at a right angle and attached to a pole (pipe) or other extension portion to lower and insert into the lateral pipe. Insertion is typically on the upstream side of the lateral pipe

In addition, a process of positioning and operating the flow-through plug system 30 is also contemplated to be part of the disclosure. The process includes the sewer plug system 30 comprising an elongated pipe having an angled elbow (e.g., 90-degrees in some embodiments) at the bottom or one end of the pipe, and an inflatable rubber member whereby the pipe passes through the center of the rubber. The assembly/system 30 is lowered down cleanout 20 until it is in contact with the lateral pipe invert. The assembly then is moved so as to insert the rubber plug 40 into the lateral pipe 18 on the upstream side of the cleanout. For example, the extension portion can be moved transverse to its longitudinal length to move a portion of the plug into the upstream side of the lateral pipe. This places the elongated pipe against the pipe wall of the clean out riser pipe. A pump or vacuum device is connected to the top of the elongated pipe. This device and method of use ensures public safety and mitigates odors from migrating up a service pipe, mitigates any discharge of sewage mixing with thermal set resin, and allows a process whereby sewer service is maintained.

The rigidity of the pipe section 32 overcomes the use of a flexible member, as a flexible member would not be able to be positioned through the cleanout and into the lateral pipe.

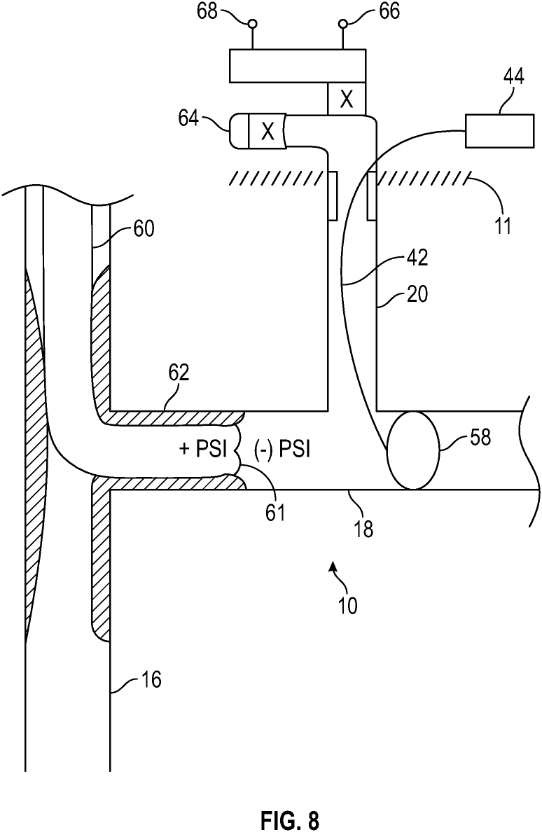

Additional aspects and/or embodiments are shown in FIG. 8. FIG. 8 shows a pipe system 10 that includes a main pipe 16 with a lateral or service pipe 18 extending therefrom. A cleanout 20 has been dug and connected to the lateral 18 from the surface/grass 11. The figure further shows portions of the main and lateral pipes having been repaired, such as via the CIPP process. A bladder 60 has been inverted into the pipes to press a liner 62 that has been saturated with a curable resin against the walls of the pipes. Once the resin is cured, the liner/resin 62 will form the new interior wall of the pipes. Generally, a positive pressure (as shown within the bladder 60 by the “+PSI”) is provided to the interior of the bladder 60 to invert, move, and press the liner 62 against the walls of the pipe.

Typically, a liner/bladder might require 10 PSI to invert, and that higher pressure elongates the liner and also squeezes more resin out of the liner. It is better to invert at lower pressures and not elongate the liner tube and to keep the resin in the tube because that produces a stronger pipe with less stress on the liner material. Also, there are situations where the liner is long and the tail portion (collapsed tube not inverted yet) of the liner produces more drag that requires more positive pressure to cause the liner tube to invert.

Therefore, aspects of the disclosure include adding a negative pressure (shown by “(-) PSI”) on the exterior of the bladder 60, such as to engage the inverting face 61 thereof in the pipe being repaired. By adding vacuum, the system can reduce the positive pressure required and not over stress the liner tube.

To accomplish the addition of the negative pressure, FIG. 8 shows that a plug 58, which may be of the flow through sort shown and described herein (e.g., with regard to plug 40 herein) at an upstream location of the cleanout 20 in the pipe system. The plug may also be a standard, non-flow through style plug that blocks the pipe. A vacuum 64 or other negative pressure source can then be positioned to provide negative pressure in the pipe in front of the inverting face 61 of the bladder. The cleanout can be fitted with a threaded cap that could be used to attach a vacuum conduit.

Additionally, the plug 58, whether flow through or non-flow through, could be connected to an air source 44 via a conduit to provide positive pressure for inflation. Gauges, such as a temperature gauge 66 and pressure gauge 68 could be provided to monitor the operation of the pipe repair. Thus, the addition of the plug and added negative pressure could reduce the amount of positive pressure needed to invert and press the bladder, which provides a better end result for the repaired pipe.

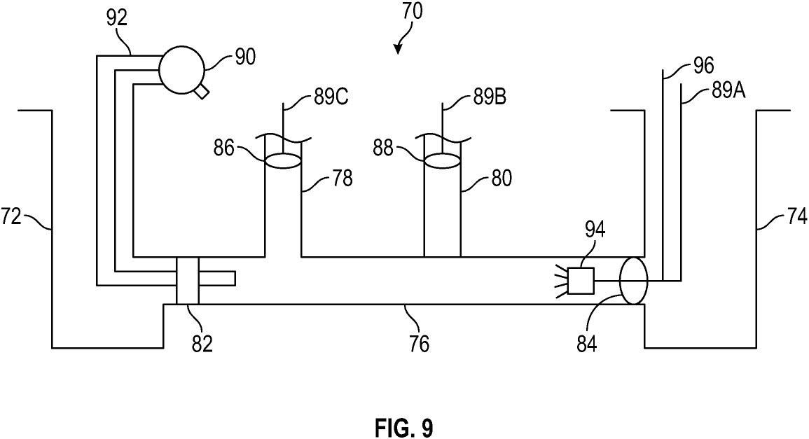

Still additional aspects and/or embodiments of the disclosure are shown in FIG. 9. For the repair of a pipe using the CIPP system, it is important to prove that the new pipe liner is watertight. Today, this is done via an air test by plugging all service connections and setting plugs at both upstream and downstream manholes to effectively isolate the sewer piping system including the main pipe and all service pipes. This typically includes the service pipes to the property line where a cleanout is located. Approximately 4 PSI is added to the pipeline and if the pressure drops the test fails. However, the test does not identify where the leak is located in the pipe.

A better test system and method is shown in FIG. 9. In the figure, a pipe system 70 includes an upstream manhole 72, a downstream manhole 74, an main pipe 76 extending between the manholes, and several service pipes 78, 80 extending from the main pipe. The service pipes extend generally to a property or structure. As shown in the figure, the method and system includes plugging the pipe system at multiple locations. This includes at the entrance to the downstream manhole 74 via a first plug 84, and in each of the service pipes via the second plug 86 and the third plug 88. A flow through plug 82 can be positioned in the main pipe 76 adjacent the upstream manhole 72, such as at the opening of the main pipe.

The first plug 84 would have an opening in the center just large enough for a camera cable 96 to pass through the plug. This allows for the pipeline to be isolated yet allows for a camera 94 to move through the main pipe 76. The camera 94 also is outfitted with a lateral camera that is launched up into each lateral pipe 78, 80, thereby inspecting the entire pipeline.

The test comprises inspecting the pipeline under negative pressure. The negative pressure source 90 (i.e., a vacuum) can be connected to the pipeline at any opening by using a flow through plug 82. For example, an inflatable sewer plug made of rubber or similar materials is sized for an 8″ pipe and includes a 2″ iron pipe 92 passing through its center extending from one end to the other. The plug 82 is inserted into the main pipe at the opposite manhole where the camera is inserted. As shown in the figure, the flow through plug 82 is positioned at the upstream manhole 72 and the camera plug 84 is positioned at the downstream manhole 74. A 2″ vacuum hose is connected to the 2″ pipe that passes through the plug 82 and this provides the source for vacuum to cause the negative pressure in the pipeline. The camera 94 would move through all of the pipes of the pipe system 70 while the system is under the pressure, and the images provided by the camera would be viewed by an operator, such as remotely from the interior. This could be on site or at a location away from the pipe system.

If the pipeline has any leaks, the camera can show groundwater entering into the pipe under vacuum, and the operator can identify exactly where the leak is located. It should be noted that if there is no water on the outside of the pipe, then the camera would not be able to show the leakage. However, when a sewer pipe leaks, it typically saturates the soils around the pipe, thereby providing a source of water that most of the time would be viewable via the camera. Users of such a system would need to take steps to protect the pipe from excessive negative pressure that could collapse the pipe.

Therefore, a system, process, and/or apparatus for providing an inflatable sewer plug designed to be inserted down a cleanout pipe and inserted into the upstream side of the clean out in the pipeline has been shown and described. The plug is outfitted with a flow through pipe capable of passing sewage flow through the pipe and the pipe being connected to a vacuum source or other pump to evacuate the sewage. The purpose is to plug the upstream side of the cleanout, taking the sewer lateral pipe out of service so the pipe downstream of the cleanout to the city owned main pipe is not affected by sewage flow during pipe rehabilitation, yet the building occupants have sewer service maintained and there’s no interruption to service. In cases where this plug is used to simply plug the upstream side of a sewer service, a device in the riser portion of the flow-through pipe may be outfitted with a floating flag similar to that of a fishing bobber, with the flag to be read for visual notification as the flow may rise in the pipe with the floating flag until the flag pops out of the pipe where it is noticeable by workers in the facility. Likewise, a sensor can be positioned in the flow through riser pipe to sense water level and trigger an audible alarm. As noted, the systems, methods, and/or apparatus provided herein prevents or otherwise mitigates flow from entering the lateral pipe between the cleanout and the main, prevents or otherwise mitigates sewage from entering the main pipe, and prevents or otherwise mitigates emissions from migrating into a strucutre, which protects the public’s health during the pipe rehabilitation.

From the foregoing, it can be seen that the invention accomplishes at least all of the stated objectives.

1. A method of blocking flow from a sewer service pipe during repair of one or more pipes of a pipe system, the method comprising:
inserting an inflatable sewer plug into the pipe system via a substantially vertical cleanout, said plug including a pipe portion extending through an inflatable portion;
positioning the inflatable sewer plug so the inflatable portion is positioned at least partially into an upstream or downstream section of the pipe system.

2. The method of claim 1, wherein flow is maintained through the service pipe via the pipe and the cleanout through the pipe portion of the inflatable sewer plug when the inflatable portion if inflated in the pipe system.

3. The method of claim 1, wherein the inflatable sewer plug positioned such that a portion of the pipe is oriented in an approximately horizontal direction prior to inserting the plug into the cleanout and during vertical movement therein, and wherein the inflatable sewer plug further comprises an extension portion extending out of the cleanout.

4. The method of claim 3, wherein the step of positioning the inflatable plug at least partially into the service pipe comprises applying a force substantially perpendicular to the longitudinal length of the extension portion.

5. The method of claim 4, wherein the pipe portion of the inflatable plug comprising a substantially horizontal portion and a substantially vertical portion extending at an angle to the substantially horizontal portion.

6. The method of claim 5, wherein the substantially vertical portion of the pipe portion of the inflatable plug extending at least partially vertically in the cleanout when the substantially horizontal portion facing the upstream portion of the service pipe.

7. The method of claim 1, wherein the inflatable sewer plug mitigates flow from entering the downstream portion of the service pipe relative to the cleanout during pipe rehabilitation.

8. The method of claim 1, wherein the inflatable sewer plug mitigates emissions of the pipe rehabilitation from entering the upstream portion of the service pipe relative to the cleanout.

9. A method of repairing a section of a pipe system, comprising:
connecting to a pipe of the pipe system via a cleanout in the ground and an aperture through a wall of the pipe;
plugging a section of the pipe using a flow-through plug system comprising a pipe section comprising an upper portion and a lower portion extending at an angle relative to the upper portion, and a plug positioned on the lower portion of the pipe section and substantially surrounding said lower portion, wherein the plug is expanded against the pipe;
repairing the pipe downstream of the flow-through plug system using a CIPP repair system.

10. The method of claim 9, further comprising evacuating material that is at an upstream location of the flow-through plug system via the flow-through pipe section.

11. The method of claim 10, wherein an extension conduit is connected to the pipe section to aid in directing the material via the flow-through plug system.

12. The method of claim 11, wherein the step of evacuating material comprises using a vacuum to move the material from the pipe to an evacuation location.

13. The method of claim 9, further comprising monitoring the presence of material at an upstream location of the flow-through plug system to provide a visual identification when material is present thereat.

14. The method of claim 9, further comprising expanding the plug by inflating said plug with a fluid.

15. A system for repairing a pipe, comprising:
a flow-through plug system comprising a pipe section comprising an upper portion and a lower portion extending at an angle relative to the upper portion, and a plug positioned on the lower portion of the pipe section and substantially surrounding said lower portion, wherein the plug is expanded against the pipe;
a fluid source for expanding the plug in the pipe; and
an evacuation system to move material from within the pipe and through the flow-through plug system to an evacuation location.

16. The system of claim 15, further comprising an extension conduit connecting the pipe section of the flow-through plug system and the evacuation location.

17. The system of claim 16, further comprising a pump to move the material via the flow-through plug system and extension conduit.

18. The system of claim 17, further comprising a monitoring system to provide visual indication, at a location external of the pipe, of the present of material in the pipe to be evacuated via the flow-through plug system and extension conduit.

19. The system of claim 15, wherein the lower portion of the pipe section extends from the upper portion at an angle between about 45-degrees and about 135-degrees.

20. The system of claim 19, wherein the lower portion of the pipe section extends from the upper portion at an approximately 90-degree angle.

21. A flow-through plug system for use in repairing one or more pipes of a sewer pipe system, said pipe system comprising a main pipe and at least one lateral pipe extending therefrom, and wherein a cleanout is provided to access the at least one lateral pipe via the cleanout, the plug system comprising:
a pipe section comprising an upper portion and a lower portion extending at an angle relative to the upper portion;
a plug positioned on the lower portion of the pipe section and substantially surrounding said lower portion; and
a fluid source operatively connected to the plug to expand said plug in a pipe of the sewer pipe system, wherein the plug substantially blocks flow in the pipe when expanded;
wherein the pipe section and plug inserted via the cleanout to a location where the lower portion is positioned in and facing an upstream portion of the at least one lateral pipe and the upper portion at least partially in the cleanout, and when inflated, the plug contacting the wall of the at least one lateral pipe.

22. The flow-through plug system of claim 21, wherein the plug comprises a rubber material fluidly sealed on the pipe section.

23. The flow-through plug system of claim 21, wherein the lower portion of the pipe section extends from the upper portion at an angle between about 45-degrees and about 135-degrees.

24. The flow-through plug system of claim 23, wherein the lower portion of the pipe section extends from the upper portion at an approximately 90-degree angle.

25. The flow-through plug system of claim 21, further comprising an extension conduit operatively connected to the upper portion of the pipe section.

26. The flow-through plug system of claim 25, further comprising an evacuation system operatively connected to the extension conduit.

27. The flow-through plug system of claim 26, wherein the evacuation system comprises:
a. a portable vacuum or a vacuum truck;
b. a pump connected to a container; or
c. a pump connected to a second pipe system.

28. The flow-through plug system of claim 27, further comprising an alert system operatively connected to the pipe section for alerting the presence of sewage.

29. The flow-through plug system of claim 21, wherein the fluid source comprises an air source for inflating the plug.
